(19) United States
(12) Patent Application Publication
(10) Pub. No.: US 2025/0153392 A1
(43) Pub. Date: May 15, 2025

(54) METHOD, SYSTEM, AND DEVICE FOR PRE-TENSIONING CONCRETE

(71) Applicant: Felix SORKIN, Stafford, TX (US)

(72) Inventor: Felix SORKIN, Stafford, TX (US)

(21) Appl. No.: 18/946,663

(22) Filed: Nov. 13, 2024

Related U.S. Application Data
(60) Provisional application No. 63/598,222, filed on Nov. 13, 2023.
(60) Provisional application No. 63/553,782, filed on Feb. 15, 2024.

(51) Int. Cl. B28B 23/04

(52) U.S. Cl. CPC B28B 23/043

(57) ABSTRACT

The present application pertains to pre-tensioning machine for prestressing concrete. The machine includes a hydraulic circuit with a hydraulic pump and a hydraulic cylinder contained within a stanchion. The stanchion having a nose piece to fit around a tendon. The machine further includes an interface having a controller and a display. The machine may be coupled to a tendon and put tension on that tendon using the hydraulic cylinder as controlled at the interface by an operator.

### RELATED APPLICATIONS

This application claims priority to U.S. Provisional Application 63/598,222, entitled “Method, System, and Device for Pre-Tensioning Concrete,” filed on Nov. 13, 2023. The contents of this priority application are incorporated by reference herein in their entirety.

### FIELD OF THE DISCLOSURE

The present disclosure relates to pre-tensioning jacks and methods of use.

### BACKGROUND

Pre-stressed concrete is structural concrete in which internal stresses are introduced to reduce potential tensile stresses in the concrete resulting from applied loads. Pre-stressing may be accomplished by post-tensioned pre-stressing or pre-tensioned pre-stressing. In post-tensioned prestressing, a tension member is tensioned after the concrete has attained a desired strength by use of a post-tensioning tendon. The post-tensioning tendon may include for example and without limitation, anchor assemblies, the tension member, and sheathes.

In pre-tensioned pre-stressing, a tension member is tensioned before concrete is poured into a form. Once the concrete has cured, the tension on the pre-tensioned member is released, thereby resulting in a compressive force in the cured concrete.

Traditionally, a tension member is constructed of a material that can be elongated and may be a single or a multi-strand cable. The tension member may be formed from a metal, such as reinforced steel. The pre-tensioning tendon traditionally includes an anchor assembly at each end of a form in which concrete will be poured. The tension member is fixedly coupled to a fixed anchor assembly positioned at one end of the pre-tensioning tendon, the “fixed end,” and stressed at the opposite end before the pretensioned cable is secured on the stressed end such that the cable retains tension while concrete is poured around the tensioned tendon and while the poured concrete cures.

GTI offers a pre-tensioning devices which are durable, field tested and proven designs, such as those depicted in FIG. 1.

However, it may be beneficial to provide a pre-tensioning system overcomes various deficiencies of the existing systems.

### SUMMARY

Exemplary embodiments include a pre-tensioning machine including a body structure; a hydraulic cylinder mounted external to the body structure and fluidly coupled to a hydraulic circuit; a hydraulic pump fluidly coupled to the hydraulic circuit and mounted internally in the body structure; a stressing ram coupled to the hydraulic cylinder and contained within a stanchion.

Exemplary embodiments may further include a plurality of wheels mounts on the body structure; a hardened nose piece mounted on the end of the stanchion opposite the stressing ram; a control panel; a yoke and a trailer hitch mounted on the body structure, and a level mounted on the stanchion for alignment prior to stressing.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows prior art pre-tensioning devices.

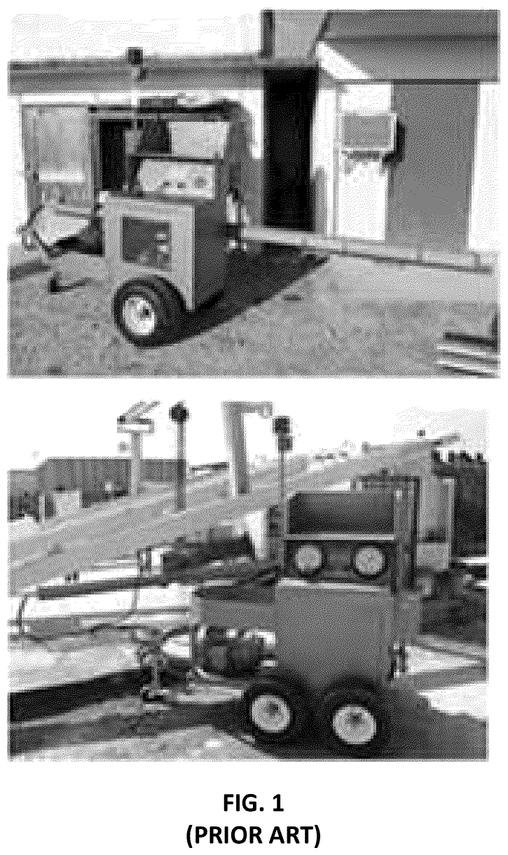

FIG. 2 shows a side view of an exemplary pre-stressing device according to an embodiment of the present disclosure.

FIG. 3A shows a perspective view of the exemplary pre-stressing device according to an embodiment of the present disclosure.

FIG. 3B shows a second perspective view of the exemplary pre-stressing device according to an embodiment of the present disclosure.

FIG. 4 shows an exemplary control panel of a pre-stressing device according to an embodiment of the present disclosure.

FIG. 5 shows a second view of the exemplary control panel of a pre-stressing device according to an embodiment of the present disclosure.

FIG. 6 shows another view of the exemplary control panel of a pre-stressing device according to an embodiment of the present disclosure.

These and other objects, features and advantages of the exemplary embodiments of the present disclosure will become apparent upon reading the following detailed description of the exemplary embodiments of the present disclosure, when taken in conjunction with the appended paragraphs.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

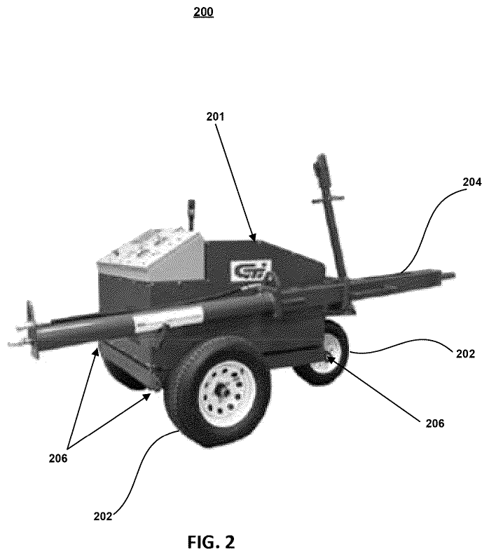

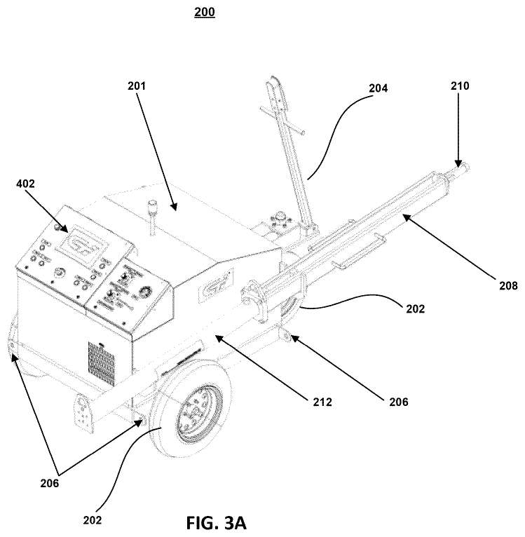

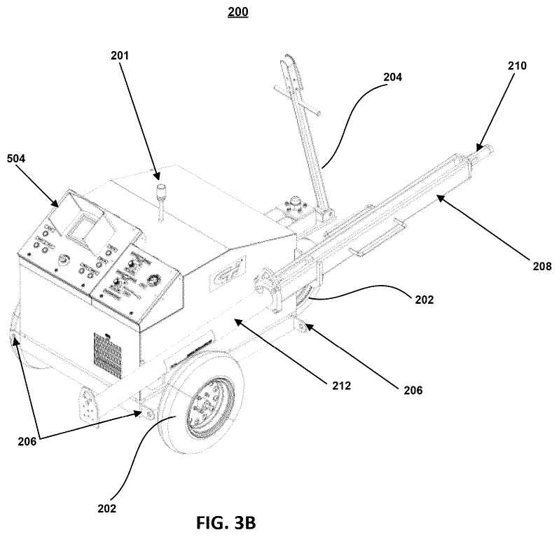

Exemplary embodiments of the present disclosure may include a complete pre-tensioning system in a single packaged device or machine. An exemplary embodiment is shown at 200 in FIGS. 2 and 3A/3B. Exemplary embodiments may be used for concrete prestressing operations, including for precast concrete.

As depicted in FIGS. 2 and 3, exemplary pre-tensioning machines according to the present disclosure may include a body 201 with oversize wheels and tires, such as tires 202, to facilitate manual moving and orientation. In various embodiments, there may be three or four tires. Some embodiments may have two tires. A retractable heavy-duty draw bar and hitch 204 may be incorporated in exemplary embodiments for towing the machine with a variety of motorized vehicles. In some embodiments, the pre-tensioning machine may include a number of lifting eyes mounted at or near the corners of the machine, such as shown at 206. These lifting eyes may be sufficiently strong to support the weight of the machine so that they may be used to lift the machine for movement/orientation purposes.

Exemplary embodiments of the present disclosure may include a regen valve design built into the hydraulic circuit for increased jack extension/return speeds and an automatic decompression circuit built into the hydraulic system to reduce and/or eliminate shock load prior to cylinder 212 returning after stressing. In some embodiments, the machine may include a cylinder stanchion 208 that incorporates an extended nose design 210 for closely spaced strands on a fixture. Exemplary embodiments may accommodate about 1.5 to about 2.5, or about 2-inch centerlines from chuck to chuck. Further, the machine may include a replaceable hardened nose piece. Embodiments may include a built in level on the cylinder stanchion to aid with cylinder alignment and chuck for straight inline pulls on a strand. The hydraulic circuit may be internal to the body 201 and may include a hydraulic pump fluidly coupled to the hydraulic circuit to provide pressure to the hydraulic system and to power the cylinder 212.

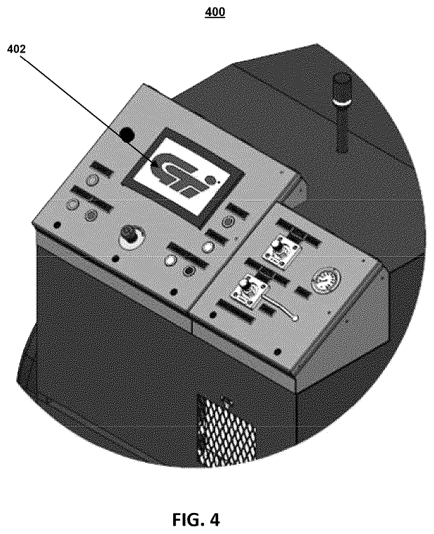

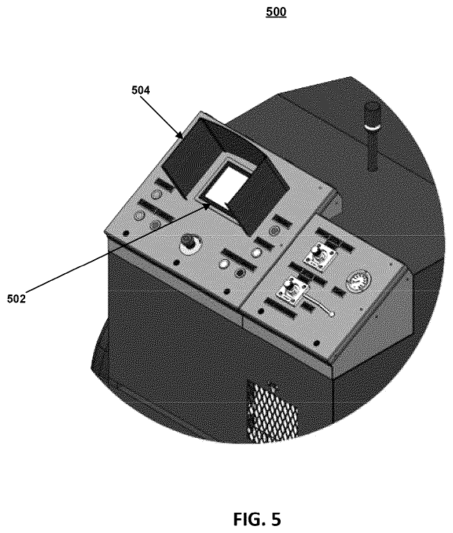

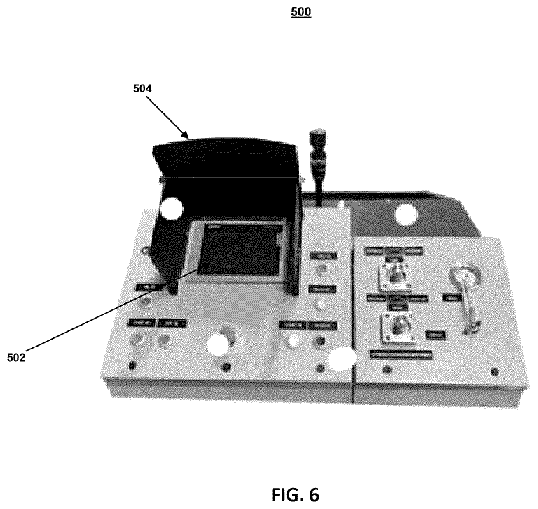

An exemplary control panel is shown 400 and 500 in FIGS. 4, 5, and 6. This control panel may be used with the machine 200. For example, exemplary embodiments may include a programmable logic controller (“PLC”) controlled unit with a human to machine interface (“HMI”) display 502, as depicted in FIGS. 5 and 6. The HMI may be utilized for set point inputs, force/load display, and/or step by step operation of the system. Such design may lend itself to a user-friendly and/or intuitive set up and operational platform. The HMI may include a dual purpose retractable sun shade 504. When retracted the sunshade can function as a protective cover and can also be locked in a closed mode for security, as depicted in FIG. 4 at 402. FIG. 3A depicts the sunshade 504 in a retracted position 402 (like FIG. 4), while FIG. 3B depicts the sunshade 504 in a raised position (like FIG. 5). The retracted position may be used when the machine is being transported.

According to exemplary embodiments of the present disclosure, the high pressure hydraulic system of the disclosed machine may employ a smaller hydraulic cylinder size, as compared to other solutions, thereby reducing the weight of the pre-tensioning machine. The machine may include a pressure-compensated and/or variable volume pump operably connected with the hydraulic system. Exemplary hydraulic systems according to the present disclosure may be capable of generating 5000 or more PSI of pressure. Pressure and/or load control may be accomplished through a load sensing control on the hydraulic pump.

Further, exemplary embodiments may provide for a variety of power requirements. For example, some embodiments may require 230 VAC 3-phase power while other embodiments may require 460 VAC 3-phase power. Other voltages may be available on yet further embodiments.

Exemplary embodiments of the present disclosure may include one or more automatic indicator lights that illuminate when both initial & final pressures have been met. For example, an operator may not have to watch a pressure gauge when pre-tensioning for verification of both load points. Embodiments may further include capability for programming up to 32 different form/job settings which may be stored into the PLC. On each job every final pull value for each strand may be automatically recorded. Elongation values can also be entered on each pull as well. In exemplary embodiments, reports may be downloaded from the HMI via USB port or wirelessly and may be printed from any operably connected computer-local and/or remote.

### Specific Embodiments

1. A pre-tensioning machine comprising:
   a body structure;
   a hydraulic cylinder mounted external to the body structure and fluidly coupled to a hydraulic circuit;
   a hydraulic pump fluidly coupled to the hydraulic circuit and mounted internally in the body structure; and
   a stressing ram coupled to the hydraulic cylinder and contained within a stanchion.
2. The pre-tensioning machine of embodiment 1 further comprising:
   a plurality of wheels mounted on the body structure;
   a yoke and trailer hitch mounted on the body structure;
   a hardened nose piece mounted on the end of the stanchion opposite the stressing ram; and
   a control panel mounted on the body structure opposite the yoke and trailer hitch.
3. The pre-tensioning machine of any embodiment, further comprising:
   a level mounted on the stanchion for alignment prior to stressing.
4. The pre-tensioning machine of any embodiment, further comprising:
   the hydraulic circuit comprising a regen valve and an automatic decompression circuit.
5. The pre-tensioning machine of any embodiment, wherein the nose piece is replaceable.
6. The pre-tensioning machine of any embodiment, wherein the machine is configured to accommodate about a 2-inch centerline measured from chuck to chuck.
7. The pre-tensioning machine of any embodiment, wherein the hydraulic pump has a working pressure of at least about 3000, or at least about 5000 PSI and is one of pressure-compensated or variable volume pump.
8. The pre-tensioning machine of any embodiment, which further comprises a load sensing control for pressure and load control on the hydraulic pump.
9. The pre-tensioning machine of any embodiment, further comprising:
   a programmable logic controller (PLC) that is configured to control operation of the hydraulic circuit.
10. The pre-tensioning machine of any embodiment, further comprising:
   a human to machine interface (HMI) display to is configured for one or more of: set point inputs, force and load display and step by step operation of the pre-tensioning machine.
11. The pre-tensioning machine of any embodiment, the control panel further comprising one or more indicator lights for displaying when an initial and final pressures are achieved.
12. The pre-tensioning machine of any embodiment, the PLC further comprising data logging to store preset jobs.
13. The pre-tensioning machine of any embodiment, wherein the data logging stores final load and elongation parameters achieved for every pull within each job.
14. The pre-tensioning machine of any embodiment, wherein job reports are saved in a pdf format on the PLC and are configured to be downloadable wirelessly or via USB port.
15. The pre-tensioning machine of any embodiment, wherein the plurality of tires comprise three tires.
16. The pre-tensioning machine of any embodiment, further comprising:
   a retractable sun-shade surrounding the HMI.
17. The pre-tensioning machine of any embodiment, further comprising:
   a power input configured to receive one of 230 VAC 3-phase power or 460 VAC 3-phase power.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

1. A pre-tensioning machine comprising:
a body structure; and
a hydraulic cylinder mounted external to the body structure on a side of the body structure, and contained within a stanchion and fluidly coupled to a hydraulic circuit that is mounted internally in the body structure.

2. The pre-tensioning machine of claim 1 further comprising:
a plurality of wheels mounted on the body structure;
an extended nose design mounted on the end of the stanchion opposite the stressing ram; and
a control panel.

3. (canceled)

4. The pre-tensioning machine of claim 1, further comprising:
the hydraulic circuit comprising a hydraulic pump, a regen valve and an automatic decompression circuit.

5. The pre-tensioning machine of claim 2, wherein the extended nose design comprise a replaceable nose piece.

6. The pre-tensioning machine of claim 1, wherein the machine is configured to accommodate about a 2-inch centerline measured from chuck to chuck.

7. The pre-tensioning machine of claim 4, wherein the hydraulic pump has a working pressure of at least about 3000 PSI and is one of pressure-compensated or variable volume pump.

8. (canceled)

9. (canceled)

10. The pre-tensioning machine of claim 1, further comprising:
a human to machine interface (HMI) display that is configured for one or more of: set point inputs, force and load display and step by step operation of the pre-tensioning machine.

11. (canceled)

12. The pre-tensioning machine of claim 10, further comprising a capability for data logging to store preset jobs.

13. The pre-tensioning machine of claim 12, wherein the data logging stores final load and elongation parameters achieved for every pull within each job.

14. The pre-tensioning machine of claim 13, wherein job reports are saved in a pdf format and are configured to be downloadable wirelessly or via USB port.

15. The pre-tensioning machine of claim 2, wherein the plurality of wheels comprise three tires.

16. The pre-tensioning machine of claim 10, further comprising:
a retractable sun-shade surrounding the HMI.

17. (canceled)

18. The pre-tensioning machine of claim 2, further comprising:
a yoke and a trailer hitch mounted on the body structure.

19. The pre-tensioning machine of claim 18, wherein the control panel is mounted on the body structure opposite the yoke and trailer hitch.
